(19) United States
(12) Patent Application Publication
(10) Pub. No.: US 2023/0085484 A1
(43) Pub. Date: Mar. 16, 2023

(54) POWER SAVING METHOD AND APPARATUS, DEVICE, AND READABLE STORAGE MEDIUM

(71) Applicant: BEIJING XIAOMI MOBILE SOFTWARE CO., LTD., Beijing (CN)

(72) Inventor: Yang LIU, Beijing (CN)

(73) Assignee: BEIJING XIAOMI MOBILE SOFTWARE CO., LTD., Beijing (CN)

(21) Appl. No.: 17/904,078

(22) PCT Filed: Feb. 13, 2020
(86) PCT No.: PCT/CN2020/075096

§ 371 Date: Aug. 11, 2022

(51) Int. Cl. H04W 52/02; H04W 68/02

(52) U.S. Cl. CPC H04W 52/0229; H04W 52/0212; H04W 68/02

(57) ABSTRACT

A power saving method and apparatus, a device, and a readable storage medium, which relate to the field of communications. Said method comprises: acquiring configuration information, the configuration information being used to configure a terminal to skip a paging occasion (201). By sending instruction information to the terminal, and configuring, in the instruction information, a first information field for instructing to skip paging detection of a paging occasion, the terminal can skip paging detection of the paging occasion according to the first information field, and the terminal does not need to perform paging detection on each paging occasion, thereby reducing power consumption of the terminal.

### TECHNICAL FIELD

The present disclosure relates to the field of communications, and in particular, to a power saving method, apparatus, device and readable storage medium.

### BACKGROUND

The terminal wakes up for paging detection regardless of whether it has its own paging message, resulting in high power consumption of the terminal.

### SUMMARY

The embodiments of the present disclosure provide power saving methods and apparatuses, devices, and a readable storage medium that can be used to indicate the priority of Hybrid Automatic Repeat reQuest-acknowledgement (HARQ-ACK) information of a scheduled Physical Downlink Shared Channel (PDSCH) when the base station schedules services of unused types on unlicensed frequency bands. The technical solutions are as follows.

According to an aspect of the present disclosure, there is provided a power saving method, applied to an access network device, the method including:

obtaining configuration information that is used for configuring a terminal to skip a paging occasion.

According to another aspect, there is provided a power saving method, the method including:

receiving indication information that includes a first information field for indicating to skip a paging detection for a paging occasion; and

skipping detecting the corresponding paging occasion according to the first information field.

According to yet another aspect, there is provided a power saving apparatus, applied to an access network device, the apparatus including:

a processing module configured to obtain configuration information that is used for configuring a terminal to skip a paging occasion.

According to yet another aspect, there is provided a power saving apparatus, applied to a terminal, the apparatus including:

a receiving module configured to receive indication information that includes a first information field for indicating to skip a paging detection for a paging occasion; and

a processing module configured to skip detecting the corresponding paging occasion according to the first information field.

According to yet another aspect, there is provided an access network device, the access network device including a processor and a transceiver connected to the processor. The processor is configured to load and execute executable instructions to implement the power saving method as described in above embodiments of the present disclosure.

According to yet another aspect, there is provided a terminal, the terminal including a processor and a transceiver connected to the processor. The processor is configured to load and execute executable instructions to implement the communication method as described in above embodiments of the present disclosure.

According to yet another aspect, there is provided a computer-readable storage medium on which at least one instruction, at least one program, a code set or an instruction set is stored. The at least one instruction, the at least one program, the code set or the instruction set is loaded and executed by a processor to implement the power saving method as described in above embodiments of the present disclosure.

The technical solutions provided by the embodiments of the present disclosure have beneficial effects including at least:

The indication information is sent to the terminal, and the first information field is configured in the indication information for indicating to skip the paging detection for the PO, so that the terminal can skip the paging detection for the PO based on the first information field without performing paging detection for each PO, thereby saving power consumption of the terminal.

### BRIEF DESCRIPTION OF THE DRAWINGS

In order to more clearly illustrate the technical solutions in the embodiments of the present disclosure, the drawings to be used in the description of the embodiments will be briefly described below, and it is obvious that the drawings in the following description are only some of the embodiments of the present disclosure, and that other drawings may be obtained from these drawings without any inventive effort by a person of ordinary skill in the art.

FIG. 1 is a block diagram of the architecture of the communication system provided by embodiments of the present disclosure.

FIG. 2 is a flow chart of a power saving method illustrated according to an exemplary embodiment of the present disclosure.

FIG. 3 is a flow chart of a power saving method illustrated according to an exemplary embodiment of the present disclosure.

FIG. 4 is a flow chart of a power saving method illustrated according to an exemplary embodiment of the present disclosure.

FIG. 5 is a structural schematic diagram of a power saving apparatus illustrated according to an exemplary embodiment of the present disclosure.

FIG. 6 is a structural schematic diagram of a power saving apparatus illustrated according to an exemplary embodiment of the present disclosure.

FIG. 7 is a block diagram of the structure of a communication device illustrated according to an exemplary embodiment of the present disclosure.

### DETAILED DESCRIPTION

In order to make the purpose, technical solutions and advantages of the present disclosure clearer, embodiments of the present disclosure will be described in further detail below in combination with the accompanying drawings.

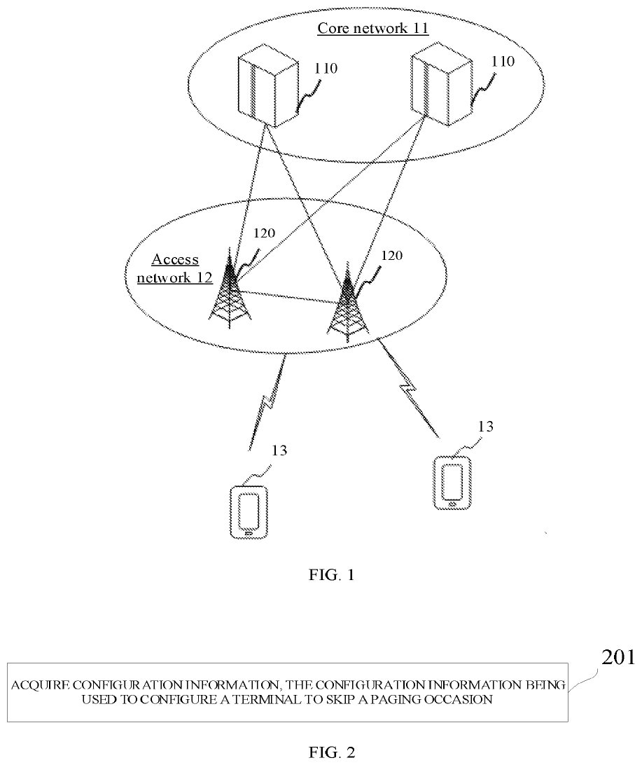

FIG. 1 illustrates a block diagram of a communication system provided by an exemplary embodiment of the present disclosure. The communication system may include a core network 11, an access network 12, and terminals 13.

The core network 11 includes several core network devices 110. The core network devices 110 include devices with Access and Mobility Management Function (AMF), Session Management Function (SMF), User Plane Function (UPF), etc. AMF is used to control the access permission of the terminal and functions such as switching. SMF is used to provide server continuity, and uninterrupted user experience of servers, such as IP address and anchor point changes.

The access network 12 includes several access network devices 120. The access network device 120 may be a base station, which is a device deployed in the access network to provide wireless communication functions to the terminal. Base stations may include various forms of macro base stations, micro base stations, relay stations, access points, etc. In systems using different wireless access technologies, the name of the device with the base station function may be different. For example, in Long Term Evolution (LTE) systems, it is called eNodeB or eNB; in 5G New Radio (NR) systems, it is called gNode B or gNB. As communication technology evolves, the term “base station” may change. For the convenience of description, the above-mentioned devices that provide wireless communication functions for terminals are collectively referred to as access network devices in the embodiments of the present disclosure.

The terminals 13 may include various handheld devices, vehicle devices, wearable devices, computing devices, or other processing devices connected to wireless modems with wireless communication capabilities, and User Equipment (UE) in various forms, Mobile Station (MS), terminal device, etc. For the convenience of description, the above-mentioned devices are collectively referred to as terminals. The access network device 120 and the terminal 13 communicate with each other via some radio interface technology, such as a Uu interface. 5G-based industrial sensors, video surveillance and wearable devices etc. may not need to support such a large bandwidth, especially for industrial sensors, which require only a few megabytes of transmission bandwidth. Such terminals may be classified as a new type of terminal in subsequent versions of 5G enhancements, with corresponding improvements in technical features.

Optionally, the process of wireless communication between the terminal 13 and the access network device 120 as described above may be carried out via licensed frequency bands or unlicensed frequency bands.

In the idle state, the terminal may need to perform paging detection according to the paging occasion cycle. A simple explanation of how the terminal implements paging detection is provided below.

The access network device configures several Paging Occasions (POs) and corresponding control channel resource information in a Synchronization Signal and Physical

Broadcast Channel (PBCH) Block (SSB) cycle.

The terminal calculates its own paging occasion position according to the formula in R15 38.304 using information such as the terminal's Identifier (ID). When the paging occasion is reached, the terminal detects Paging Downlink Control Information (Paging DCI) based on the configured control channel resource information.

The terminal obtains the paging category according to the content of the DCI. If it is the category of the paging message scheduling, the terminal demodulates the corresponding Physical Downlink Shared Channel (PDSCH) message (this resource is also indicated in the DCI).

After demodulating the PDSCH message, the terminal checks the terminal ID in it, and if there is no its own ID, the terminal continues to wait until the next paging occasion and then repeats the above process. However, the above paging detection process consumes more power, which raises the power consumption of the terminal.

The communication system and the business scenarios described in the embodiments of the present disclosure are intended to illustrate the technical solutions of the embodiments of the present disclosure more clearly and do not constitute a limitation of the technical solutions provided by the embodiments of the present disclosure. A person of ordinary skill in the art would know that as communication systems evolve and new business scenarios emerge, the technical solutions provided by the embodiments of the present disclosure are also applicable to similar technical problems.

FIG. 2 is a flow chart of a power saving method provided according to an exemplary embodiment of the present disclosure. Taking the method applied to an access network device as an example for description, as shown in FIG. 2, the method includes:

Step 201, obtaining configuration information that is used for configuring a terminal to skip a paging occasion.

Optionally, the configuration information is used for configuring the terminal to skip the paging occasion when the terminal is in an idle state. That is, the solution provided by the embodiments of the present disclosure is applicable to the case where the terminal is in the idle state. When the terminal is in the idle state, the terminal is configured to skip the paging occasion. Optionally, the access network device determines whether a paging message for the terminal exists, and obtains configuration information if a paging message for the terminal does not exist. The paging message includes at least one of a short message and a paging scheduling message. The paging scheduling message is used for indicating the frequency information, time information, modulation coding mode, reference signal, subcarrier spacing, etc. of the paging.

In the embodiments of the present disclosure, the access network device configures the terminal to skip the paging occasion according to the type of the terminal. For one or more terminals that are connected to the same access network device, the standards used by the terminals grouped into one group are the same. For example, a group of terminals all use R17 standard, or a group of terminals all use R15 or R16 standard. Optionally, the terminals grouped into a group use the same standard and have the same terminal type. For example, Reduced Capability (RedCap) UEs using R17 standard are grouped into one group, or UEs using R15/16 standard and Enhance Mobile Broadband (eMBB) UEs using R17 standard are grouped into one group. In this way, for the same group of terminals, the access network device may send the same format of messages, so that the solution provided by the present application is not only applicable to the terminals of R17 standard, but also compatible with the terminals of R15/16 standard.

After the core network groups the paging occasions of terminals, the access network device obtains the grouping result of the paging occasions of terminals from the core network, obtains terminal identifiers of terminals and generates a list of terminal identifiers, and configures one or more terminal identifiers of which paging detection is to be skipped. For example, the identifiers of RedCap UEs of R17 standard in the above-mentioned group are added to the list of terminal identifiers, and the list of terminal identifiers is sent to the terminal through a paging message. Since the Paging DCI is used to transmit the indication information between the access network device and the terminal, the original step of obtaining the terminal identifier is retained in order to be consistent with the original paging detection process, while the terminal identifier in the list of terminal identifiers indicates a terminal that can skip paging detection. In other words, when a terminal receives the paging message and obtains the list of terminal identifiers from it, the terminal can skip the paging detection when the list of terminal identifiers includes the terminal's identifier.

The access network device may further determine the number of skipped cycles for the terminal to skip detecting the paging occasion. In the embodiments of the present disclosure, the access network device, in determining the number of cycles to skip detecting the paging occasion, first predicts the arrival of paging according to the radio resource management algorithm and the scheduler's situation, and then determines, based on the prediction results, the number of cycles of the paging occasion of which the detection needs to be skipped to achieve the effect of power saving.

Optionally, the access network device, after obtaining the configuration information, sends indication information to the terminal based on the configuration information, the indication information including a first information field used for indicating to skip the paging occasion. The indication information includes any kind of: physical layer signaling, Radio Resource Control (RRC) signaling, Media Access Control Element (MAC CE). Embodiments of the present disclosure are illustrated with the indication information implemented as physical layer signaling, optionally, the indication information is Downlink Control Information (DCI), which is the Paging DCI.

For example, when all of the Redcap UEs of R17 standard in the above paging group are in the idle state, the access network device obtains configuration information used for configuring one or more Redcap UEs of R17 standard to skip the paging occasion, and sends the Paging DCI to the Redcap UEs of R17 standard in the above-mentioned group. The Paging DCI includes a first information field for indicating to skip the paging occasion, which is used for indicating the one or more Redcap UEs of R17 standard to skip detecting the paging occasion, thereby achieving the effect of power saving.

Optionally, the Paging DCI is partially redefined in R17 standard, where the structure of the Paging DCI includes a 2-bit indicator field, which is referenced in Table I below.

TABLE I

| Bit | |
|---|---|
| field | Indicator content |
| 00 | Reserved |
| 01 | Only scheduling information for Paging is present in the DCI |
| 10 | Only short message is present in the DCI |
| 11 | Both scheduling information for Paging and short message are |
| | present in the DCI |

Here, “00” indicates the subsequent reserved field (i.e., “Reserved”), “01” indicates that only the scheduling information for paging is present in the DCI; “10” indicates that only short message is present in the DCI; and “11” indicates that both the scheduling information for paging and short message are present in the DCI. In the embodiments of the present disclosure, “00” in the Paging DCI is defined as Paging Skipping, i.e., “00” indicates to skip paging detection for the paging occasion.

The value of the first information field is predefined, that is, the above 2-bit indicator field in the Paging DCI is the first information field, and the predefined value 00 is the value of the first information field, which indicates to skip the paging detection for the paging occasion.

In summary, in the power saving method provided by the present disclosure, the access network device obtains configuration information so that the access network device has the ability to configure the terminal to skip the paging occasion, thereby enabling the terminal to skip the paging detection for the paging occasion without performing paging detection for each paging occasion, and saving the power consumption of the terminal.

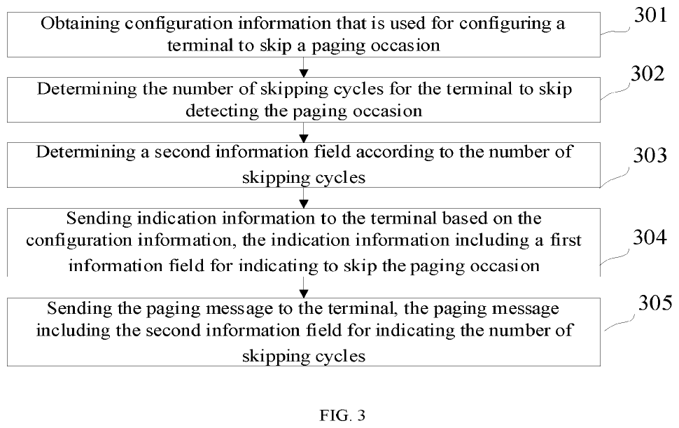

In an optional embodiment, the indication information further includes a second information field for indicating the number of skipped cycles. FIG. 3 is a flow chart of a power saving method provided in another exemplary embodiment of the present disclosure. Taking the method applied to an access network device as an example for illustration, as shown in FIG. 3, the method includes:

Step 301, obtaining configuration information that is used for configuring a terminal to skip a paging occasion.

Optionally, the configuration information is used for configuring the terminal to skip the paging occasion when the terminal is in an idle state. That is, the solution provided by the embodiments of the present disclosure is applicable to the case where the terminal is in the idle state. When the terminal is in the idle state, the terminal is configured to skip the paging occasion. Optionally, the access network device determines whether a paging message for the terminal exists, and obtains configuration information if a paging message for the terminal does not exist.

Step 302, determining the number of skipped cycles for the terminal to skip detecting the paging occasion.

The configuration information also includes the number of skipped cycles for the terminal to skip detecting the paging occasion. The access network device may also determine the number of skipped cycles for the terminal to skip detecting the paging occasion, and determine a second information field based on the number of skipped cycles. In the embodiments of the present disclosure, the access network device, in determining the number of cycles to skip detecting the paging occasion, first predicts the arrival of paging according to the radio resource management algorithm and the scheduler's situation, and then determines the number of cycles to skip detecting paging occasion based on the prediction results to achieve the effect of power saving. The access network device may predict the number of paging occasion cycles of paging detection that can be skipped by respective terminals in a group of terminals, and then select, based on the number of cycles that can be skipped by the terminals other than the terminals with the number of cycles that can be skipped of zero, the minimum number of paging occasion cycles of paging detection that can be skipped or the average number of paging occasion cycles of paging detection that can be skipped, as the number of paging occasion cycles of paging detection that can be skipped to be carried in the DCI message.

Step 303, determining a second information field according to the number of skipped cycles.

Optionally, the number of skipped cycles is indicated by the second information field. The second information field is sent to the terminal via a paging message, that is, the access network device sends the terminal a paging message that carries a second information field indicating the number of skipped cycles. Optionally, the access network device sends the paging message to a group of terminals based on the grouping of the terminals, and the paging message carries the second information field indicating the number of skipped cycles.

Optionally, the paging message further includes a list of terminal identifiers, and the list of terminal identifiers includes one or more terminal identifiers for skipping the paging detection. The terminal, upon receiving the paging message, determines whether the terminal's identifier is included in the list of terminal identifiers, and when the list of terminal identifiers includes the terminal's identifier, it determines that the terminal can skip the detection of the paging occasion, thereby determining the number of skipped cycles for skipping the paging occasion based on the second information field in the paging message.

Step 304, sending indication information to the terminal based on the configuration information, the indication information including a first information field for indicating to skip the paging occasion.

Optionally, the indication information is Downlink Control Information (DCI), which is the Paging DCI.

The value of the first information field is predefined, that is, the above 2-bit indicator field in the Paging DCI is the first information field, and the predefined value 00 is the value of the first information field, which indicates to skip the paging detection for the paging occasion.

Step 305, sending the paging message to the terminal, the paging message including the second information field used for indicating the number of skipped cycles.

First, the access network device determines the terminal that needs to skip paging detection, and determines the number of skipped cycles for the terminal to skip paging detection when the terminal skips paging detection.

Optionally, all bits of the second information field are used for indicating the number of skipped cycles, or, part of the bits of the second information field are used for indicating the number of skipped cycles.

Optionally, a corresponding skipped cycle number is defined based on the indicator bits in the paging message. Optionally, the number of skipped cycles is defined by 8 bits included in the paging message, or, the number of skipped cycles is defined by a portion of the 8 bits.

Optionally, the terminal, upon receiving the indication information, skips detecting the corresponding paging occasion according to the first information field in the indication information.

In summary, in the power saving method provided by the present disclosure, the access network device obtains configuration information so that the access network device has the ability to configure the terminal to skip the paging occasion, thereby enabling the terminal to skip the paging detection for the paging occasion without performing paging detection for each paging occasion, and saving the power consumption of the terminal.

In the method provided by this embodiment, the indication information is sent to the terminal, and the first information field is configured in the indication information for indicating to skip the paging detection for the paging occasion, so that the terminal can skip the paging detection for the paging occasion based on the first information field without performing paging detection for each paging occasion, thereby saving power consumption of the terminal.

In the method provided by this embodiment, the second information field indicates the number of skipped cycles for skipping the paging detection in the paging message, and the terminal can skip the corresponding cycles according to the number, ensuring power saving while avoiding missing normal paging, and ensuring normal communication.

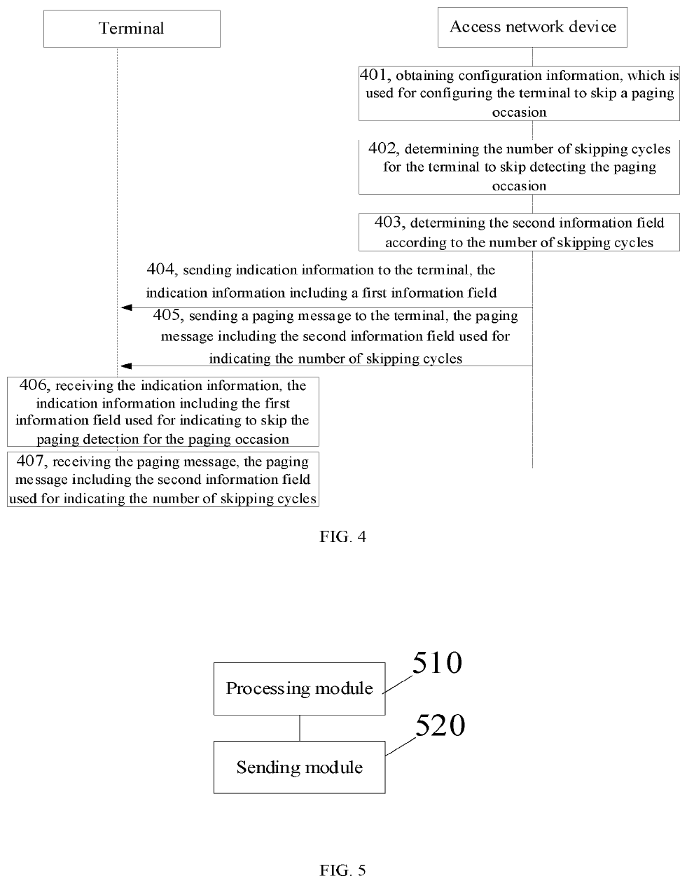

FIG. 4 is a flow chart of a power saving method provided in another exemplary embodiment of the present disclosure. Taking the method applied to a terminal or an access network device as an example for illustration, the method includes:

Step 401, obtaining, by the access network device, configuration information, which is used for configuring the terminal to skip a paging occasion.

Optionally, the configuration information is used for configuring the terminal to skip the paging occasion when the terminal is in an idle state. That is, the solution provided by the embodiments of the present disclosure is applicable to the case where the terminal is in the idle state. When the terminal is in the idle state, the terminal is configured to skip the paging occasion. Optionally, the access network device determines whether a paging message for the terminal exists, and obtains configuration information if a paging message for the terminal does not exist.

When the access network device determines that a group of terminals are all in the idle state, it obtains the configuration information of the group of terminals, which is used for configuring the group of terminals to skip the paging occasion.

Step 402, determining, by the access network device, the number of skipped cycles for the terminal to skip detecting the paging occasion.

The configuration information also includes the number of skipped cycles for the terminal to skip detecting the paging occasion. The access network device may also determine the number of skipped cycles for the terminal to skip detecting the paging occasion, and determine a second information field based on the number of skipped cycles. In the embodiments of the present disclosure, the access network device, in determining the number of cycles to skip detecting the paging occasion, first predicts the arrival of paging according to the radio resource management algorithm and the scheduler's situation, and then determines the number of cycles to skip detecting paging occasion based on the prediction results to achieve the effect of power saving. The access network device may predict the number of paging occasion cycles of paging detection that can be skipped by respective terminals in a group of terminals, and then select, based on the number of cycles that can be skipped by the terminals other than the terminals with the number of cycles that can be skipped of zero, the minimum number of paging occasion cycles of paging detection that can be skipped or the average number of paging occasion cycles of paging detection that can be skipped, as the number of paging occasion cycles of paging detection that can be skipped to be carried in the DCI message.

Step 403, determining, by the access network device, the second information field according to the number of skipped cycles.

Optionally, the number of skipped cycles is indicated by the second information field. The second information field is sent to the terminal via a paging message, that is, the access network device sends the terminal a paging message that carries a second information field indicating the number of skipped cycles. Optionally, the access network device sends the paging message to a group of terminals based on the grouping of the terminals, and the paging message carries the second information field indicating the number of skipped cycles.

Step 404, sending, by the access network device, indication information to the terminal, the indication information including a first information field.

Optionally, the indication information is Downlink Control Information (DCI), which is the Paging DCI.

Step 405, sending, by the access network device, a paging message to the terminal, the paging message including the second information field used for indicating the number of skipped cycles.

First, the access network device determines the terminal that needs to skip paging detection, and determines the number of skipped cycles for the terminal to skip paging detection when the terminal skips paging detection.

Optionally, all bits of the second information field are used for indicating the number of skipped cycles, or, part of the bits of the second information field are used for indicating the number of skipped cycles.

Step 406, receiving, by the terminal, the indication information, the indication information including the first information field used for indicating to skip the paging detection for the paging occasion.

Step 407, receiving, by the terminal, the paging message, the paging message including the second information field used for indicating the number of skipped cycles.

Optionally, after receiving the indication information and obtaining the first information field, the terminal continues to receive the paging message. Optionally, before skipping the paging detection for at least one paging occasion, the terminal obtains a list of terminal identifiers from the paging message, the list of terminal identifiers including one or more terminal identifiers for skipping the paging detection. In response to the list of terminal identifiers including the terminal's identifier, the terminal skips detecting the paging occasion indicated by the number of skipped cycles according to the second information field.

In this implementation, since the transmission of indication information between the access network device and the terminal utilizes paging DCI, the original step of obtaining the terminal identifier is retained in order to be consistent with the original paging detection process, while the terminal identifier in the list of terminal identifiers indicates a terminal that can skip paging detection.

Step 408, skipping, by the terminal, the paging occasion indicated by the number of skipped cycles according to the second information field.

The terminal, based on the number of skipped cycles indicated in the second information field, counts one or more paging occasions for which the detection is skipped and receives the indication information again in response to the count reaching the number of skipped cycles.

If there is a paging to the terminal within the paging occasion cycles corresponding to the number of skipped cycles, the access network device waits until the paging occasion cycles corresponding to the number of skipped cycles and then processes the paging to the terminal. For example, there are n paging occasion cycles to be skipped by the terminal, and before the n^{th} paging occasion cycle the terminal has a paging arrival, the access network device waits until the (n+1)^{th} paging occasion cycle and then forwards the paging to the terminal, where n is a positive integer.

In the method provided by this embodiment, the indication information is sent to the terminal, and the first information field is configured in the indication information for indicating to skip the paging detection for the paging occasion, so that the terminal can skip the paging detection for the paging occasion based on the first information field and the terminal without performing paging detection for each paging occasion, thereby saving power consumption of the terminal.

FIG. 5 is a structural block diagram of a power saving apparatus provided in an exemplary embodiment of the present disclosure. Taking the apparatus applied to an access network device as an example, as shown in FIG. 5, the apparatus includes:

A processing module 510 configured to obtain configuration information that is used for configuring a terminal to skip a paging occasion.

In an optional embodiment, the configuration information is used for configuring the terminal to skip the paging occasion when the terminal is in an idle state.

In an optional embodiment, the apparatus further includes:

A sending module 520 configured to send, based on the configuration information, indication information to the terminal, wherein the indication information includes a first information field used for indicating to skip the paging occasion.

In an optional embodiment, the configuration information is used for configuring the terminal to skip the paging occasion according to a type of the terminal.

In an optional embodiment, the configuration information is used for configuring a Reduced Capability (RedCap) terminal of R17 standard to skip the paging occasion.

In an optional embodiment, the configuration information further includes the number of skipped cycles for the terminal to skip detecting the paging occasion.

The sending module 520 is further configured to send a paging message to the terminal, the paging message comprising a second information field used for indicating the number of skipped cycles.

In an optional embodiment, all bits of the second information field are used for indicating the number of skipped cycles; or

part of the bits of the second information field are used for indicating the number of skipped cycles.

In an optional embodiment, the indication information includes physical layer Downlink Control Information (DCI).

In an optional embodiment, a value of the first information field is predefined.

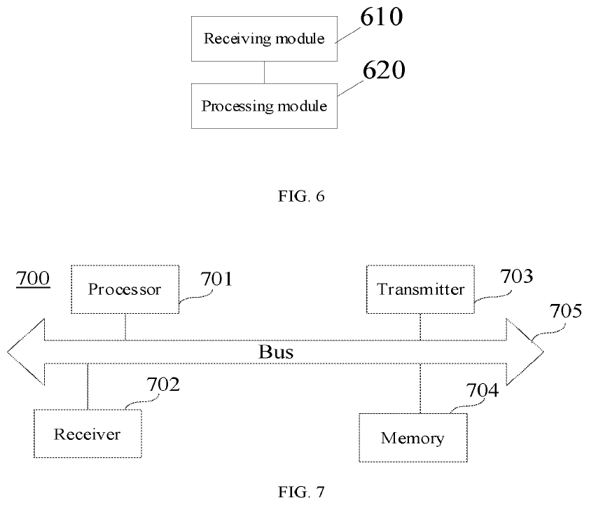

FIG. 6 is a structural block diagram of a power saving apparatus provided in an exemplary embodiment of the present disclosure. Taking the apparatus applied to a terminal as an example, as shown in FIG. 6, the apparatus includes:

A receiving module 610 configured to receive indication information that includes a first information field for indicating to skip a paging detection for a paging occasion; and

A processing module 620 configured to skip detecting the corresponding paging occasion according to the first information field.

In an optional embodiment, the receiving module is further configured to receive a paging message that includes a second information field indicating the number of skipped cycles; and

The processing module 620 is further configured to skip the paging occasion indicated by the number of skipped cycles according to the second information field.

In an optional embodiment, all bits of the second information field are used for indicating the number of skipped cycles; or

part of the bits of the second information field are used for indicating the number of skipped cycles.

In an optional embodiment, the processing module 620 is further configured to obtain a list of terminal identifiers in the paging message, the list of terminal identifiers comprising one or more terminal identifiers for skipping the paging detection; and skip, in response to the list of terminal identifiers comprising an identifier of the terminal, the paging occasion indicated by the number of skipped cycles according to the second information field.

In an optional embodiment, the processing module 620 is further configured to count one or more paging occasions for which the terminal skips the detection according to the number of skipped cycles indicated by the second information field; and

The receiving module 610 is further configured to receive, in response to the count reaching the number of skipped cycles, the indication information again.

In an optional embodiment, the indication information includes physical layer Downlink Control Information (DCI).

In an optional embodiment, a value of the first information field is predefined.

In summary, in the power saving apparatus provided by the present disclosure, the indication information is sent to the terminal, and the first information field is configured in the indication information for indicating to skip the paging detection for the paging occasion, so that the terminal can skip the paging detection for the paging occasion based on the first information field without performing paging detection for each paging occasion, thereby saving power consumption of the terminal.

FIG. 7 illustrates a structural schematic diagram of a communication device 700 (a terminal or an access network device) provided in an exemplary embodiment of the present disclosure. The terminal includes: a processor 701, a receiver 702, a transmitter 703, a memory 704, and a bus 705.

The processor 701 includes one or more processing cores, and the processor 701 performs various functional applications and information processing by running software programs and modules.

The receiver 702 and transmitter 703 may be implemented as a communication component, which may be a communication chip.

The memory 704 is connected to the processor 701 via the bus 705.

The memory 704 may be used to store at least one instruction, and the processor 701 is used to execute the at least one instruction to implement the various steps in the method embodiments described above.

In addition, the memory 704 may be implemented by any type of volatile or non-volatile storage device or a combination thereof, including but not limited to: disk or optical disk, Erasable Programmable Read Only Memory (EEPROM), Erasable Programmable Read Only Memory (EPROM), Static Random Access Memory (SRAM), Read-Only Memory (ROM), magnetic memory, Flash Memory, Programmable Read-Only Memory (PROM).

A non-transitory computer readable storage medium that enables the terminal to perform the power saving method described above when the instructions in the non-transitory computer storage medium are executed by a processor of the terminal.

In summary, in the power saving device provided by the present disclosure, the indication information is sent to the terminal, and the first information field is configured in the indication information for indicating to skip the paging detection for the paging occasion, so that the terminal can skip the paging detection for the paging occasion based on the first information field without performing paging detection for each paging occasion, thereby saving power consumption of the terminal.

A power saving system is further provided in an exemplary embodiment of the present disclosure, which includes a terminal and an access network device.

The terminal includes the power saving apparatus as provided in the embodiment shown in FIG. 5.

The access network device includes the power saving apparatus as provided in the embodiment shown in FIG. 6.

A computer readable storage medium is further provided in an exemplary embodiment of the present disclosure, which stores at least one instruction, at least one program, a code set or instruction set, the at least one instruction, the at least one program, the code set or instruction set being loaded and executed by the processor to implement the steps performed by the terminal in the power saving method provided in each of the method embodiments described above.

It should be understood that the term “a plurality of/multiple” mentioned in this disclosure refers to two or more. The term “and/or” describes the relationship of the associated objects and indicates that three relationships can exist, e.g., A and/or B, which can indicate that: A alone, both A and B, and B alone. The character “/” generally indicates that the associated objects before and after is an “or” relationship.

Other embodiments of the present disclosure will readily occur to those skilled in the art upon consideration of the specification and practice of the invention disclosed herein.

This application is intended to cover any variations, uses, or adaptations of the present disclosure that follow the general principles of the present disclosure and include common knowledge or techniques in the technical field not disclosed by the present disclosure. The specification and examples are to be regarded as exemplary only, and the true scope and spirit of the disclosure being indicated by the following claims.

It should be understood that the present disclosure is not limited to the precise structures described above and illustrated in the accompanying drawings, and that various modifications and changes may be made without departing from the scope thereof. The scope of the present disclosure is limited only by the scope of the appended claims.

What is claimed is:

1. A power saving method, applied to an access network device, comprising:
obtaining configuration information that is used for configuring a terminal to skip a paging occasion.

2. The method according to claim 1, wherein the configuration information is used for configuring the terminal to skip the paging occasion when the terminal is in an idle state.

3. The method according to claim 1, further comprising:
sending, based on the configuration information, indication information to the terminal, wherein the indication information comprises a first information field used for indicating to skip the paging occasion.

4. The method according to claim 1, wherein the configuration information is used for configuring the terminal to skip the paging occasion according to a type of the terminal.

5. The method according to claim 4, wherein the configuration information is used for configuring a Reduced Capability (RedCap) terminal of R17 standard to skip the paging occasion.

6. The method according to claim 1, wherein the configuration information further comprises the number of skipped cycles for the terminal to skip detecting the paging occasion; and
wherein the method further comprises:
sending a paging message to the terminal, the paging message comprising a second information field used for indicating the number of skipped cycles.

7. The method according to claim 6, wherein
all bits of the second information field are used for indicating the number of skipped cycles; or
part of the bits of the second information field are used for indicating the number of skipped cycles.

8. The method according to claim 1, wherein the indication information comprises physical layer Downlink Control Information (DCI).

9. A power saving method, applied to a terminal, comprising:
receiving indication information that comprises a first information field for indicating to skip a paging detection for a paging occasion; and
skipping detecting the corresponding paging occasion according to the first information field.

10. The method according to claim 9, further comprising:
receiving a paging message that comprises a second information field indicating the number of skipped cycles; and
skipping the paging occasion indicated by the number of skipped cycles according to the second information field.

11. The method according to claim 10, wherein
all bits of the second information field are used for indicating the number of skipped cycles; or
part of the bits of the second information field are used for indicating the number of skipped cycles.

12. The method according to claim 10, wherein skipping the paging occasion indicated by the number of skipped cycles according to the second information field, comprises:
obtaining a list of terminal identifiers in the paging message, the list of terminal identifiers comprising one or more terminal identifiers for skipping the paging detection; and
skipping, in response to the list of terminal identifiers comprising an identifier of the terminal, the paging occasion indicated by the number of skipped cycles according to the second information field.

13. The method according to claim 10, wherein skipping the paging occasion indicated by the number of skipped cycles according to the second information field, comprises:
counting one or more paging occasions for which the terminal skips the detection according to the number of skipped cycles indicated by the second information field; and
receiving, in response to the count reaching the number of skipped cycles, the indication information again.

14. The method according to claim 9, wherein the indication information comprises physical layer Downlink Control Information (DCI).

15. The method according to claim 9, wherein a value of the first information field is predefined.

16. A power saving apparatus, applied to an access network device, comprising:
a processing module configured to obtain configuration information that is used for configuring a terminal to skip a paging occasion.

17. The apparatus according to claim 16, wherein the configuration information is used for configuring the terminal to skip the paging occasion when the terminal is in an idle state.

18. The apparatus according to claim 16, further comprising:
a sending module configured to send, based on the configuration information, indication information to the terminal, wherein the indication information comprises a first information field used for indicating to skip the paging occasion.

19. The apparatus according to claim 16, wherein the configuration information is used for configuring the terminal to skip the paging occasion according to a type of the terminal.

20. The apparatus according to claim 19, wherein the configuration information is used for configuring a Reduced Capability (RedCap) terminal of R17 standard to skip the paging occasion.

21. The apparatus according to claim 16, wherein the configuration information further comprises the number of skipped cycles for the terminal to skip detecting the paging occasion; and
wherein the sending module is further configured to send a paging message to the terminal, the paging message comprising a second information field used for indicating the number of skipped cycles.

22. The apparatus according to claim 16, wherein
all bits of the second information field are used for indicating the number of skipped cycles; or
part of the bits of the second information field are used for indicating the number of skipped cycles.

23. The apparatus according to claim 16, wherein the indication information comprises physical layer Downlink Control Information (DCI).

24. A power saving apparatus, applied to a terminal, comprising:
a receiving module configured to receive indication information that comprises a first information field for indicating to skip a paging detection for a paging occasion; and
a processing module configured to skip detecting the corresponding paging occasion according to the first information field.

25. The power saving apparatus of claim 24, wherein the receiving module is further configured to receive a paging message that comprises a second information field indicating the number of skipped cycles; and
wherein the processing module is further configured to skip the paging occasion indicated by the number of skipped cycles according to the second information field.

26. The power saving apparatus of claim 25, wherein
all bits of the second information field are used for indicating the number of skipped cycles; or
part of the bits of the second information field are used for indicating the number of skipped cycles.

27. The power saving apparatus of claim 25, wherein the processing module is further configured to:
obtain a list of terminal identifiers in the paging message, the list of terminal identifiers comprising one or more terminal identifiers for skipping the paging detection; and
skip, in response to the list of terminal identifiers comprising an identifier of the terminal, the paging occasion indicated by the number of skipped cycles according to the second information field.

28. The power saving apparatus of claim 25, wherein the processing module is further configured to count one or more paging occasions for which the terminal skips the detection according to the number of skipped cycles indicated by the second information field; and
wherein the receiving module is further configured to receive, in response to the count reaching the number of skipped cycles, the indication information again.

29. The power saving apparatus of claim 24, wherein the indication information comprises physical layer Downlink Control Information (DCI).

30. The power saving apparatus of claim 24, wherein a value of the first information field is predefined.

31. An access network device, comprising:
a processor; and
a transceiver connected to the processor,
wherein the processor is configured to load and execute executable instructions to implement the power saving method of any one of claims 1 to 8.

32. A terminal, comprising:
a processor; and
a transceiver connected to the processor,
wherein the processor is configured to load and execute executable instructions to implement the power saving method of any one of claims 9 to 15.

33. A computer-readable storage medium, storing at least one instruction, at least one program, a code set or an instruction set, wherein the at least one instruction, the at least one program, the code set or the instruction set is loaded and executed by a processor to implement the power saving method of any one of claims 1 to 15.
